(19) United States
(12) Patent Application Publication
(10) Pub. No.: US 2026/0272222 A1
(43) Pub. Date: Sep. 17, 2026

(54) Foldable Griddle

(71) Applicants: Michael Herschel Reedy, Franklin, WI (US); Michael E. Hebert, JR., Nashua, NH (US); Wei Chieh William Tu, Hampden, ME (US); Joseph David Wilson, Dover Foxcroft, ME (US)

(72) Inventors: Michael Herschel Reedy, Franklin, WI (US); Michael E. Hebert, JR., Nashua, NH (US); Wei Chieh William Tu, Hampden, ME (US); Joseph David Wilson, Dover Foxcroft, ME (US)

(73) Assignee: Johnson Outdoors Inc., Racine, WI (US)

(21) Appl. No.: 19/560,409

(22) Filed: Mar. 9, 2026

Related U.S. Application Data
(60) Provisional application No. 63/770,174, filed on Mar. 11, 2025.

(51) Int. Cl. A47J 37/06

(52) U.S. Cl. CPC A47J 37/0682

(57) ABSTRACT

A foldable griddle including first, second, and third chassis portions. The first and second chassis portions pivotable relative to the second chassis portion between open and packed states. A first burner support frame is pivotally attached to the first chassis portion and operably slidably supported by the second chassis portion for lateral and vertical movement relative to the second chassis portion. A second burner support frame is pivotally attached to the second chassis portion and operably slidably supported by the second chassis portion for lateral and vertical movement relative to the second chassis portion. Transitioning from the open state to the packed state adjusts the vertical positioning of the first burner support frame relative to the second burner support frame and reduces a distance between laterally outermost extents of the first and second burner support frames.

### CROSS-REFERENCE TO RELATED PATENT APPLICATIONS

This patent application claims the benefit of U.S. Provisional Patent Application No. 63/770,174, filed Mar. 11, 2025, the entire teachings and disclosure of which are incorporated herein by reference thereto.

### FIELD OF THE INVENTION

This invention generally relates to camping stoves and particularly to portable camping griddles.

### BACKGROUND OF THE INVENTION

Campers have lots of gear to allow for everyday functions such as cooking, sleeping, eating, etc. As such, one particular important activity is cooking and thus important gear includes cooking devices such as portable grills and griddles. It is a never-ending quest to provide the most user-friendly camping gear, which includes both its functionality in use as well as its portability for transport to and from the campsite and compactness when not in use during storage.

Also, size of the gear matters. For example, the smaller the cooking gear, typically, the lower amount of food you can cook at one time.

Camping griddles allow you to cook a wider range of items-from pancakes and eggs to stir-fries-but most griddles are heavy and bulky to pack, and smaller ones have minimal cooking space.

One issue with grills and griddles is that while in use there is typically a large amount of the envelope thereof that is filled with simply open air. This open space thus generates unnecessary wasted space during transport and storage.

The present application relates to improvements in the state of camping stoves.

### SUMMARY

Examples provide a new and improved foldable griddle. Examples provide foldable griddle that reduces the volume of the device when transitioning from an open state to a packed state.

In an example, a foldable griddle includes a chassis, a first burner support frame, and a second burner support frame. The chassis has first, second, and third chassis portions. The first chassis portion is pivotally attached to the second chassis portion. The third chassis portion is pivotally attached to the second chassis portion. The first and third chassis portions are pivotable between open and packed states relative to the second chassis portion. The first burner support frame is operably pivotally attached to the first chassis portion and operably supported by the second chassis portion for sliding lateral and vertical movement relative to the second chassis portion. The second burner support frame is operably pivotally attached to the third chassis portion and operably supported by the second chassis portion for sliding lateral and vertical movement relative to the second chassis portion. Transitioning from the open state to the packed state adjusts vertical positioning of the first burner support frame relative to the second burner support frame and reduces a distance between laterally outermost extents of the first and second burner support frames such that the first and second burner support frames are more laterally compact in the packed state than in the open state.

In one example, a first griddle plate is supported by at least the first chassis portion in the open state and a second griddle plate is supported by at least the third chassis portion in the open state.

In one example, the second chassis portion and first burner support frame have a first cam arrangement therebetween that allows for a sliding relationship therebetween that permits both lateral adjustment and vertical adjustment of the first burner support frame relative to the second chassis portion.

In one example, the second chassis portion and second burner support frame have a second cam arrangement therebetween that allows for a sliding relationship therebetween that permits both lateral adjustment and vertical adjustment of the second burner support frame relative to the second chassis portion.

In one example, the first cam arrangement transitions the first burner support frame a first vertical direction relative to the second chassis portion and the second cam arrangement transitions the second burner support frame a second vertical direction relative to the second chassis portion. The second vertical direction is opposite the first vertical direction.

In one example, the first cam arrangement includes a first cam track provided by the second chassis portion and a first cam follower provided by the first burner support frame.

In one example, the first cam arrangement includes a first cam track provided by the second chassis portion and a first cam follower provided by the first burner support frame. The second cam arrangement includes a second cam track provided by the second chassis portion and a second cam follower provided by the second burner support frame.

In one example, the first cam track is in the form of a slot and the second cam track is in the form of a slot.

In one example, the first cam track has a first portion associated with the open state, a second portion associated with the packed state, and a transition portion that vertically offsets the first portion relative to the second portion. The second cam track has a first portion associated with the open state, a second portion associated with the packed state, and a transition portion that vertically offsets the first portion relative to the second portion. The first portion of the first cam track and the first portion of the second cam track are substantially coaxial at a same first vertical height.

In one example, the second portion of the first cam track is vertically offset from the second portion of the second cam track.

In one example, the second portion of the first cam track is vertically offset from the first vertical height. The second portion of the second cam track is vertically offset from the first vertical height. The first vertical height is vertically between the second portions of the first and second cam tracks.

In one example, first and second rotation limiters are provided by the second chassis portion. The first chassis portion engages the first rotation limiter in the open state preventing over rotation of the first chassis portion relative to the second chassis portion when transitioning from the packed state to the open state. The third chassis portion engages the second rotation limiter in the open state preventing over rotation of the third chassis portion relative to the second chassis portion when transitioning from the packed state to the open state.

In one example, a first griddle support is pivotally attached to the first chassis portion and is pivotable between a retracted state and an extended state. The first griddle plate is vertically supported on the first griddle support when in the open state and the first griddle support is in the extended state.

In one example, the first griddle plate has a locating pin and the first griddle support has a cavity. The locating pin extends into the cavity when the first griddle plate is installed during the open state.

In an example, a method of folding a foldable griddle from an open state to a packed state is provided. The method includes rotating the first chassis portion relative to the second chassis portion from the open state to the closed state. The method includes rotating the third chassis portion relative to the second chassis portion from the open state to the closed state. The method includes transitioning the first burner frame over the second burner frame while the first burner support frame remains attached to the first chassis portion and the second burner support frame remains attached to the third chassis portion.

In one example, transitioning the first burner support frame over the second burner support frame while the first burner support frame remains attached to the first chassis portion and the second burner support frame remains attached to the third chassis portion includes reducing a distance between laterally outermost extents of the first and second burner support frames.

In one example, transitioning the first burner support frame over the second burner support frame while the first burner support frame remains attached to the first chassis portion and the second burner support frame remains attached to the third chassis portion includes sliding a first cam follower of the first burner support frame along a first cam track of the second chassis portion.

In one example, the method includes sliding a second cam follower of the second burner support frame along a second cam track of the second chassis portion.

In one example, sliding the first cam follower of the first burner support frame along a first cam track of the second chassis portion adjusts a vertical position of the first burner support frame in a first vertical direction. Sliding the second cam follower of the second burner support frame along the second cam track of the second chassis portion adjusts a vertical position of the second burner support frame in a second vertical direction opposite the first vertical direction.

In an example, a foldable griddle including a chassis, a first burner support frame, a second burner support frame, and a handle is provided. The chassis has first, second, and third chassis portions. The first chassis portion is pivotally attached to the second chassis portion. The third chassis portion is pivotally attached to the second chassis portion. The first and third chassis portions are pivotable between open and packed states relative to the second chassis portion. The first burner support frame is operably pivotally attached to the first chassis portion and operably supported by the second chassis portion for sliding lateral and vertical movement relative to the second chassis portion. The second burner support frame is operably pivotally attached to the third chassis portion and operably supported by the second chassis portion for sliding lateral and vertical movement relative to the second chassis portion. The handle has a gripping portion and first and second handle portions. The gripping portion is configured to be gripped by a user. The first handle portion is pivotally attached to the first chassis portion and has an elongated channel. The second handle portion is pivotally attached to the second chassis portion and has an outward extending pin fixed relative to a gripping portion of the handle and is insertable and axially slidable within the elongated channel such that the first and second handle portions are movable relative to one another between a flat orientation and an extended orientation while the pin remains within the channel.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a foldable camping stove in the form of a portable griddle in an open or in use state;

FIG. 2 illustrates the foldable camping stove of FIG. 1 in a closed or packed state;

FIG. 3 illustrates the foldable camping stove in an open state but with the griddle plates stacked such as when the foldable camping stove is in the packed state;

FIG. 4 is a cross-sectional, perspective illustration of the foldable camping stove in the open state with the griddle plates removed;

FIG. 5 is an exploded perspective illustration of the foldable camping stove in the open state;

FIG. 6 is a cross-sectional illustration of the foldable camping stove in the open state with the griddle plates stacked;

FIG. 7 is a cross-sectional, perspective illustration of the foldable camping stove in the packed state;

FIG. 8 is a further cross-sectional, perspective illustration of the foldable camping stove in the packed state;

FIG. 9 is a cross-sectional illustration of the foldable camping stove in the packed state;

FIG. 10 is a cross-sectional illustration of the foldable camping stove in the packed state with the griddle plates and burners removed for illustrative purposes;

FIG. 11 illustrates another example of a foldable camping stove in the form of a portable griddle in an open or in use state;

FIG. 12 illustrates a bottom perspective view of the foldable camping stove of FIG. 11;

FIG. 13 is a top perspective illustration of the foldable camping stove of FIG. 11 in a closed or packed state with the handle in a carrying position;

FIG. 14 is a top perspective illustration of the foldable camping stove of FIG. 11 in a closed or packed state with the handle in a flat or storage position;

FIG. 15 is a bottom perspective illustration of the foldable camping stove of FIG. 11 in a closed or packed state;

FIG. 16 is an exploded illustration of the handle components of the handle of the foldable comping stove of FIG. 11;

FIG. 17 is a partial illustration of the camping stove of FIG. 11 illustrating rotation limiters used to position the chassis portions relative to one another in the open state;

FIG. 18 is a partially exploded illustration of the foldable camping stove of FIG. 11 in the open or in use state;

FIG. 19 is a partial illustration of the foldable camping stove of FIG. 11 in the open or in use state with a chassis portion and the griddle plates removed for better visibility of the internal components of the foldable camping stove;

FIGS. 20 and 21 are partial perspective illustrations of the foldable camping stove of FIG. 11 in the packed or closed state; and

FIG. 22 illustrates a griddle plate and associated griddle plate supports in exploded fashion.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

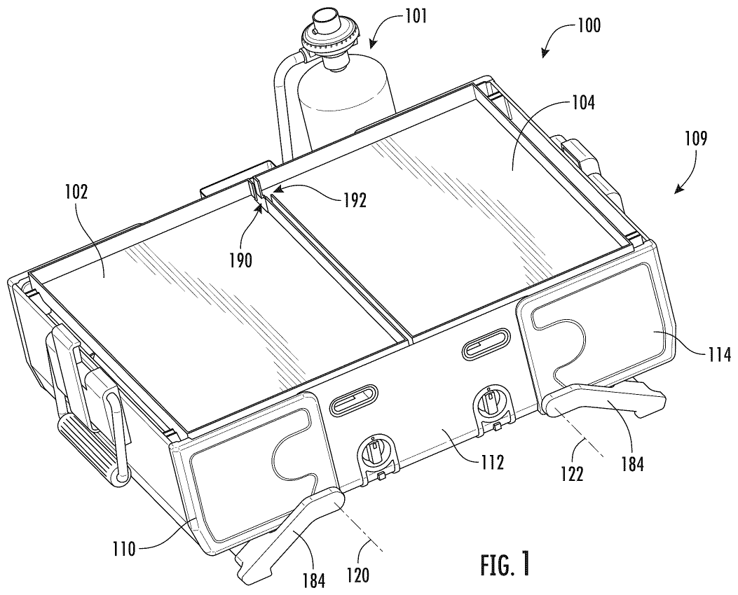

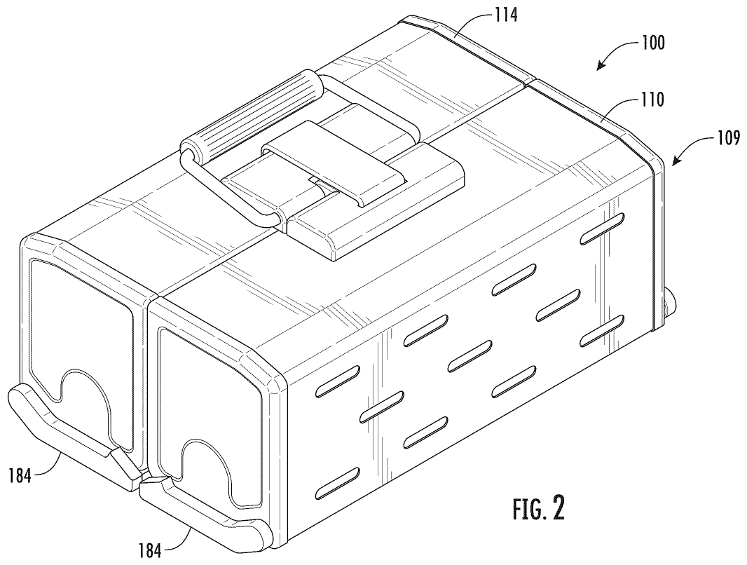

FIG. 1 illustrates a camping stove in the particular form of portable griddle 100 in its open state, e.g. during use, connected to a source of fuel 101. FIG. 2 illustrates the camping stove in its packed state, e.g. during transport and/or storage. The portable griddle 100 is thus configured to transition between the open state (FIG. 1) and the packed state (FIG. 2) to provide the benefit of a large usable griddle surface provided by first and second griddle plates 102, 104 in use but a small efficient package when in the packed state.

While illustrated in the form of a portable griddle, it is contemplated that other cooking stoves incorporating the portability features described herein but using different cooking surfaces are contemplated. For example, the camping stove could include grill grates while still utilizing the portability features described below.

The foldable griddle 100 has chassis 109 that includes first, second, and third chassis portions 110, 112, 114 that generally enclose the operational components in both the open state and packed state. Such components include burner arrangements 116, 118, ignitors, valves, etc. Notably, in the open state, the griddle surface of the griddle plates 102, 104 are exposed for use.

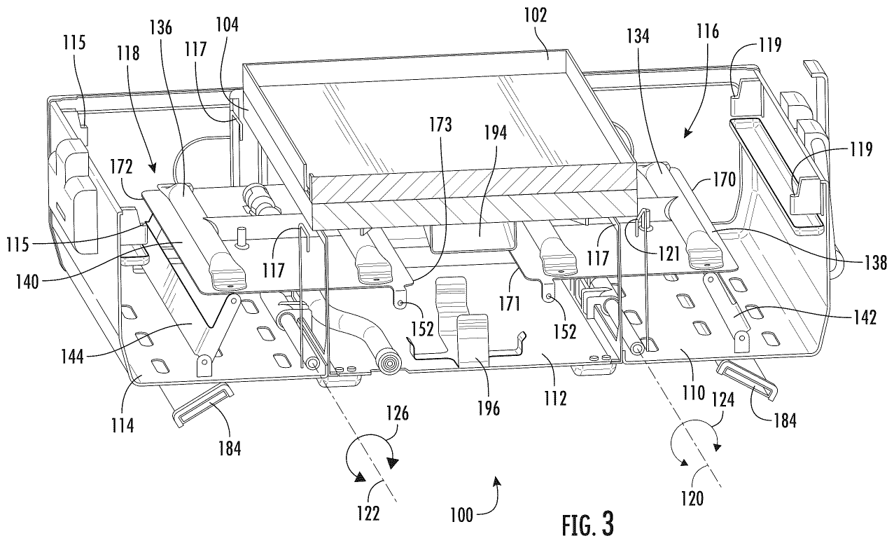

The first and third chassis portions 110, 114 are outer chassis portions and the second chassis portion 112 is an inner chassis portion. When transitioning from the open state (FIGS. 1 and 3) to the packed state (FIG. 2), the first and third chassis portions 110, 114 pivot relative to the second chassis portion 112 about axes 120, 122 as illustrated by arrows 124, 126. This folds the components into a more compact package more conducive to transport and storage. In one example, the griddle plates 102, 104 are fully encased within the chassis 109 in the packed state such that it also provides a cleaner transport configuration.

The first and second griddle plates 102, 104 are operably removably supported by the chassis 109.

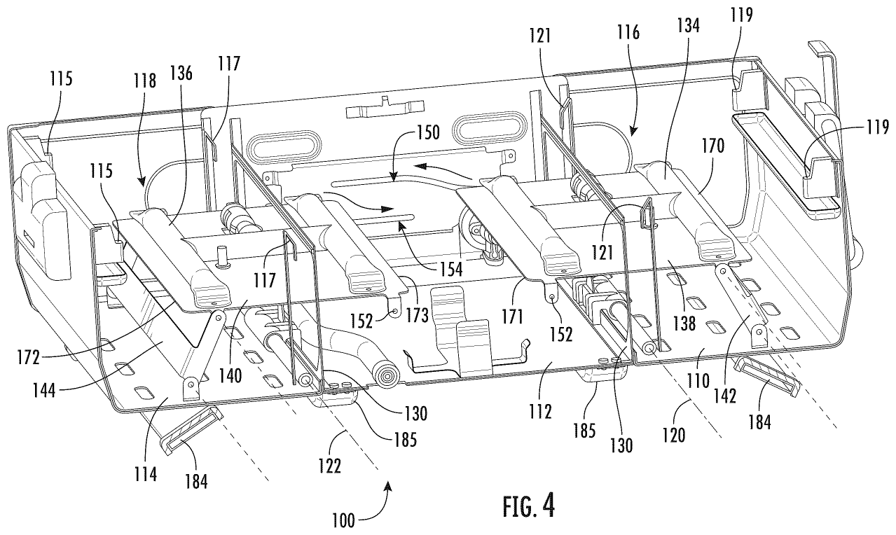

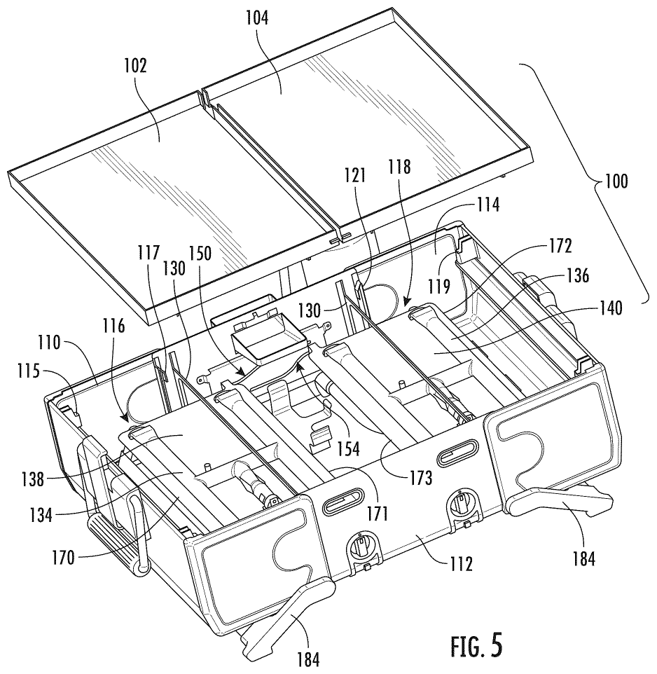

With additional reference to FIG. 4, in the illustrated example, in the open state, the first griddle plate 102 is operably supported by the first chassis portion 110. In particular, the first chassis portion has support surfaces 115, 117 for supporting the griddle plate 102. The second griddle plate 104 is operably supported by the third chassis portion 114. In particular, the second chassis portion has support surfaces 119, 121 for supporting the second griddle plate 104.

In some examples, in the open state, the first griddle plate 102 may be operably supported in part by the first and second chassis portions 110, 112. The second griddle plate 104 may be operably supported in part by the second chassis portion 112 and the third chassis portion 114. Again, support surfaces for supporting the griddle plates 102, 104 may be provided by the corresponding first, second, and third chassis portions 110, 112, 114.

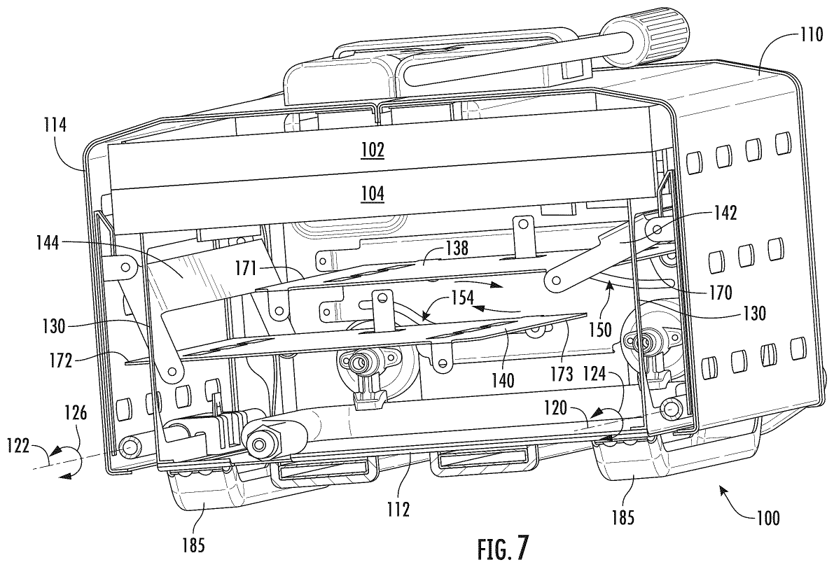

In the packed state, the griddle plates 102, 104 are generally stacked on top of one another and moved towards the center such that they are supported on framework 130 provided by the second chassis portion 112. This is illustrated in FIGS. 7-9.

The foldable griddle 100 has first and second burners 134, 136 for supplying heat to the first and second griddle plates 102, 104.

In the open state and in use, the first and second burners 134, 136 are preferably, but not required, to be at a same distance from the bottoms of the associated griddle plates 102, 104.

In the illustrated example, the burners 134, 136 are operably mounted to burner support frames. The burner support frames are configured to reposition the burners 134, 136 within the housing formed by the chassis portions 110, 112, 114 when transitioning between the open and packed states.

The burner support frames include burner support plates 138, 140 and movable support linkages illustrated in the form of swing arms 142, 144. While the burner support frames include the burner support plates 138, 140, to which the burners are mounted, other embodiments may directly incorporate the structures of burner support plates 138, 140 into the primary burner components.

Burner support plate 138 is operably movably supported by the first chassis portion 110 by way of swing arm 142. Also, burner support plate 138 is operably movably supported by second chassis portion 112 by way of a cam arrangement that includes cam tracks 150 provided by opposite ends of the second chassis portion 112 and cam followers 152 mounted to or otherwise provided by the burner support plate 138. This mounting arrangement allows for adjusting the position of the burner support plate 138 and associated burner 134 within the cavity formed by the chassis 109 when in and when transitioning between the packed and open states.

The second burner support plate 140 is similarly mounted to the second and third chassis portions 112, 114. However, the cam tracks 154 are vertically offset from the first cam tracks 150 such that the first and second burner support plates 138, 140 become vertically stacked (i.e. vertically offset) from one another in the packed state.

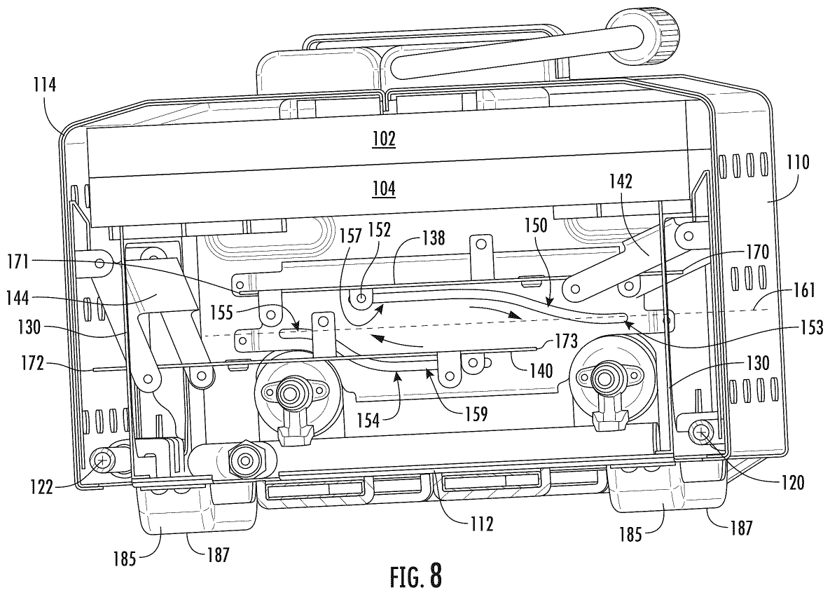

In particular and with additional reference to FIG. 8, the cam tracks 150, 154 each have portions 153, 155 associated with the open state and portions 157, 159 associated with the packed state. Notably, portions 153, 155 of the first and second tracks 150, 154 are generally vertically aligned with one another as illustrated by axis 161 as the different burner plates 138, 140 are vertically aligned in the open state.

To allow for transitioning to the stacked arrangement in the packed state, portions 157, 159 of the first and second tracks 150, 154 are vertically offset from one another as well as axis 161 with one portion 157 vertically above the other portion 159. In some examples, it is contemplated that only one of the burners need move vertically relative to the housing when transitioning from the open state to the packed state. Thus, each track 150, 154 has a transition region that transitions between the corresponding portions (e.g. between portion 153/157 or 155/159) that allow for the vertical change in position.

As illustrated in FIG. 8, the first burner support plate 138 and associated burner 134 are positioned vertically above the second burner support plate 140 and associated burner 136 in the packed state.

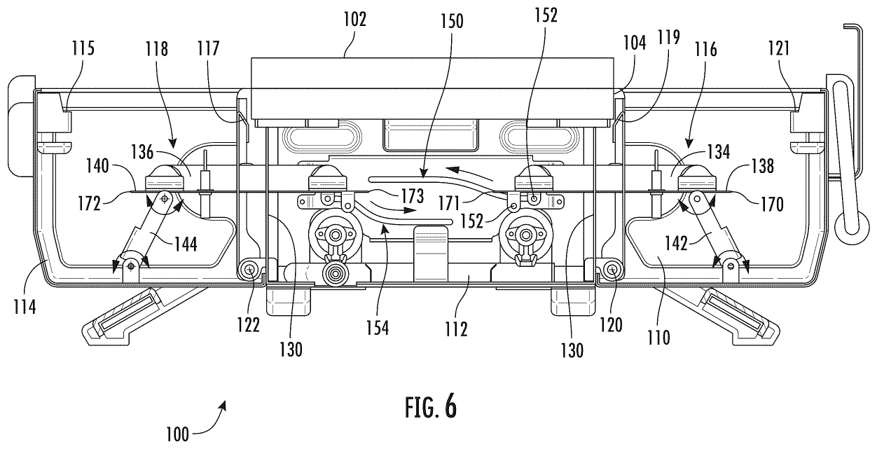

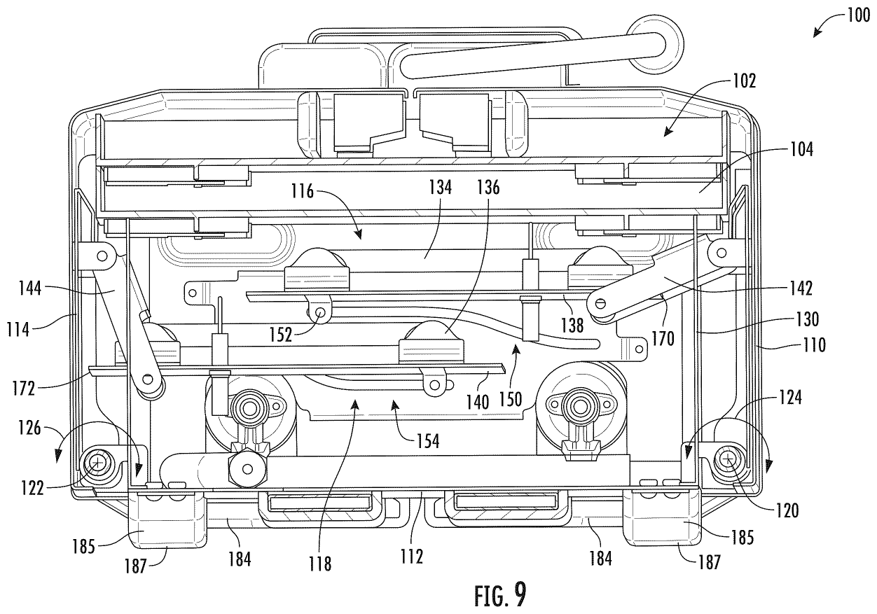

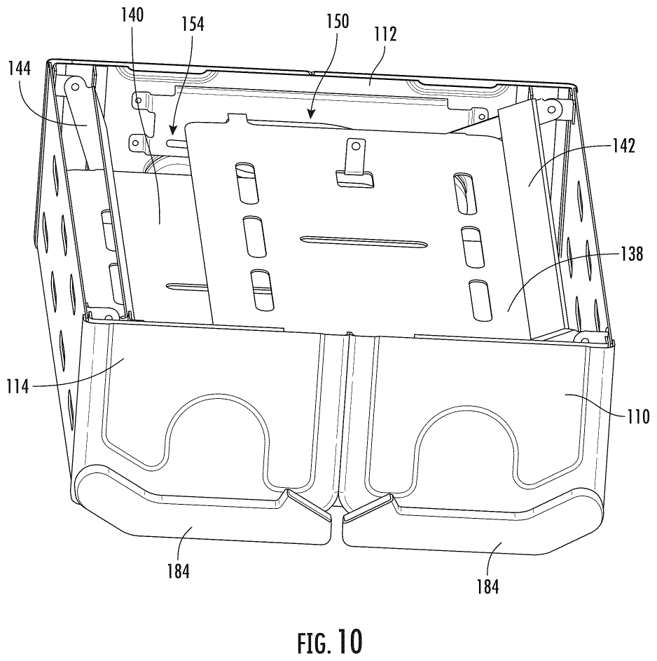

Not only are the burner support plates 138, 140 movable vertically relative to one another, they are laterally movable relative to one another when transitioning between the open and packed states. In the open state, the burner support plates 138, 140 are generally laterally offset from one another parallel to axis 161. In the packed state, they get shifted inward such that they now laterally overlap. Here, the distance measured parallel to axis 161 between the outermost extents of the burner support plates 138, 140 in the open state is greater than the distance between the outer most extents 170, 172 of the burner support plates 138, 140 in the closed state. This is illustrated when comparing FIG. 3 or 6 with FIG. 8 or 9.

In this example, the swing arms 142, 144 are positioned closer to the outer most extents 170, 172 while the cam followers 152 are located closer to the inner most extents 171, 173.

While the swing arms 142, 144 are illustrated as a single piece mounted at opposite sides of the corresponding first and third chassis portions 110, 114, other examples may have the swing arms 142, 144 be multiple components. For example, each burner support plate 138, 140 could have a pair of linkages coupled thereto at opposed sides thereof. Further, while each swing arm 142, 144 is illustrated as being pivotally connected to the burner support plates 138, 140 and corresponding chassis portions 110, 114, other connections may also incorporate linear slidability to facilitate transitioning between the open state and packed state.

Thus, the foldable griddle 100 allows for providing a large cooking surface in the open state but a compact reduced space packed state.

In one example, the illustrated configuration can have dimensions of 18.5″ D×11.5″ W×8.3″ H (~1765 in³) in the packed state and 18.5″ D×24.5″ W×7.6″ H (~3445 in³) in the open state. As such, this is almost a 50% reduction in the volume of space required in the packed state than in the open state significantly reducing the store/transportation required in the packed state.

Other features of the griddle 100 include that the burners can be individually controlled to provide independently controlled heat to the individual griddle plates.

The ignition may be Piezo ignition. The igniters may be carried with the corresponding burners when transitioning between the open state and packed state.

The legs 184 can fold in and out to support the griddle 100 in the open state and fold up to reduce the amount of space required during the packed state.

Some examples will include support slides 185 to support the griddle 100 when the legs 184 are folded in the packed state. These slides 185 make it easier to slide the griddle 100 in and out of a vehicle as the provide a long sliding surface 187 as opposed to the feet of legs 184 that can get more easily hung up when moving the griddle 100. As illustrated in FIG. 9, when the legs 184 are folded up and not in use, the slides 185 project downward further than legs 184 to prevent interference of legs 184 with the surface upon which the griddle 100 rests. However, the use of legs 184 with the corresponding feet can make the griddle 100 more sturdy on uneven ground such as when the griddle 100 is in use.

Further, the griddle plates 102, 104 have grease drains 190, 192 formed proximate corners thereof. Below these drains 190, 192 can be supported a grease drip tray 194 (see FIG. 3). Typically, the grease drip tray 194 will be supported by the second chassis portion 112 below the drains 190, 192.

In the packed state, the grease drip tray 194 can be removed and mounted in holding clip 196 to prevent it from moving around during transport. The clip 196 may have spring loaded arms for easy insertion and removal during setup and take down of the griddle 100.

While illustrated in the form of a griddle, it is contemplated that the folding concepts described herein could be incorporated into a grill.

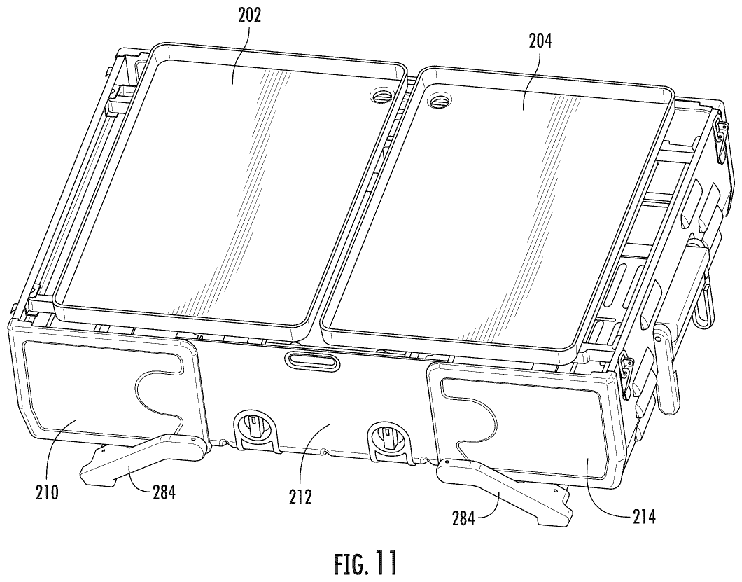

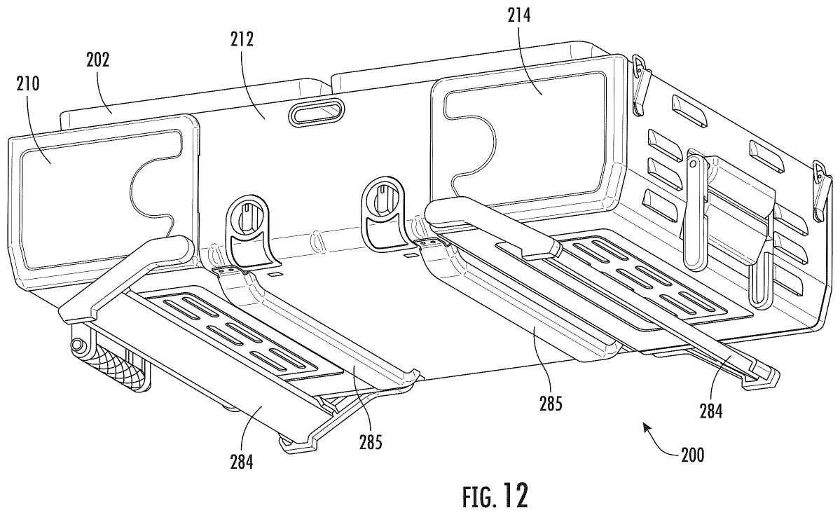

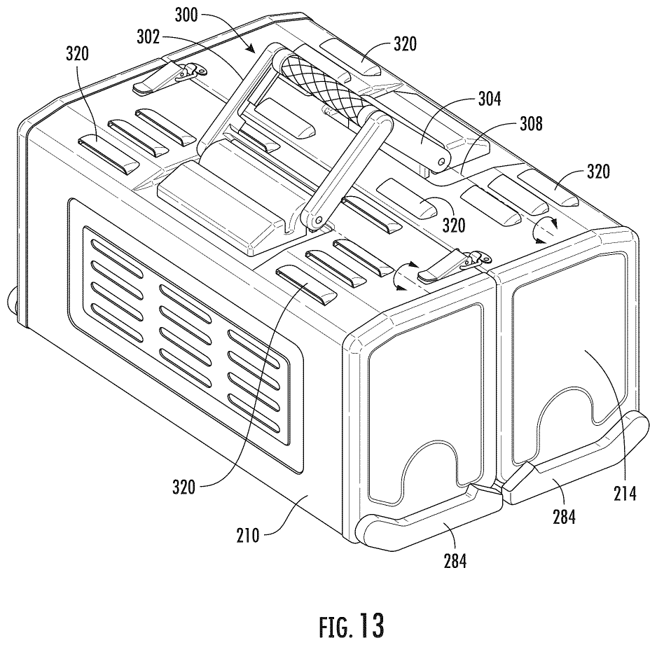

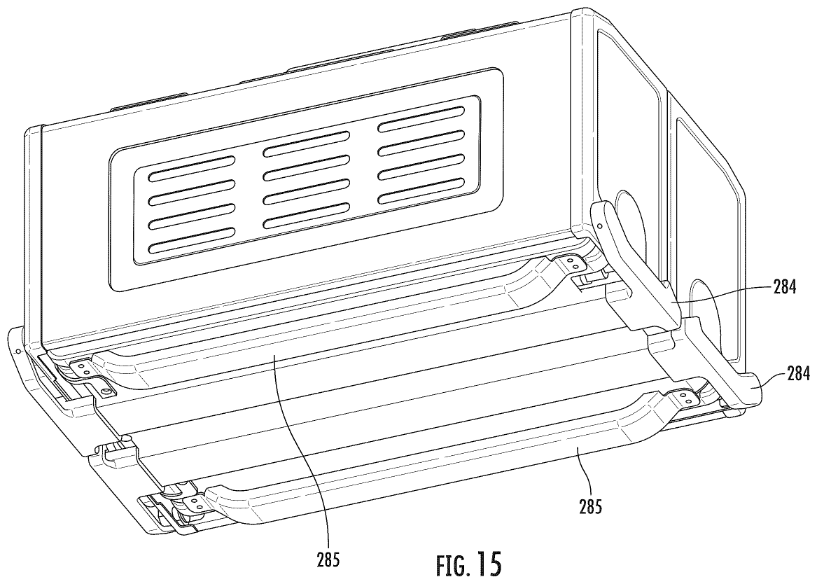

FIGS. 11 and 12 illustrates a further example of a foldable griddle 200 in an open state. FIGS. 13-15 illustrate foldable griddle 200 in the packed state. Foldable griddle 200 is substantially similar to foldable griddle 100 discussed previously. As such, any of the discussions above for griddle 100 apply to griddle 200 unless contradictory.

Foldable griddle 200 includes first and second griddle plates 202, 204. Also, griddle 200 has a similar chassis formed from first, second and third chassis portions 210, 212, 214.

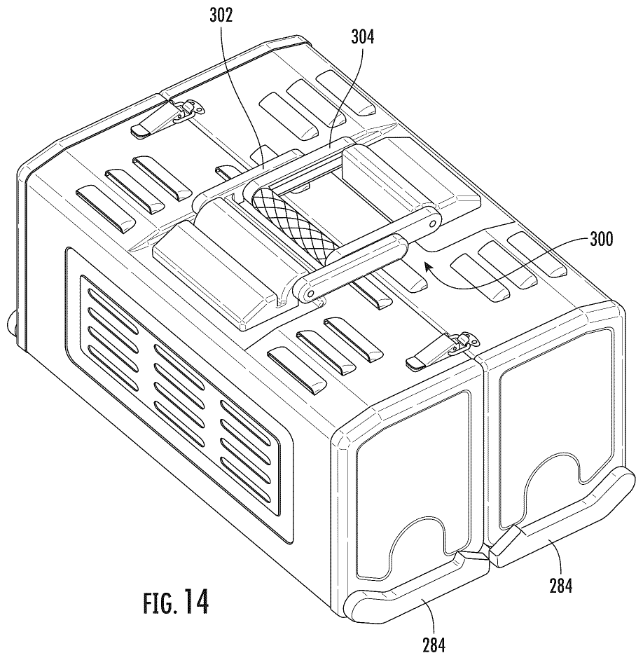

Griddle 200 has a modified handle 300. Handle 300 has two handle portions 302, 304 that operably interact with one another. Handle portions 302, 304 are hingedly attached to the tops of first and third chassis portions 210, 214 for rotation about axes 306, 308. This allows the handle 300 to transition between an upstanding useable configuration (see FIG. 13) and a flat storage configuration (see FIG. 14).

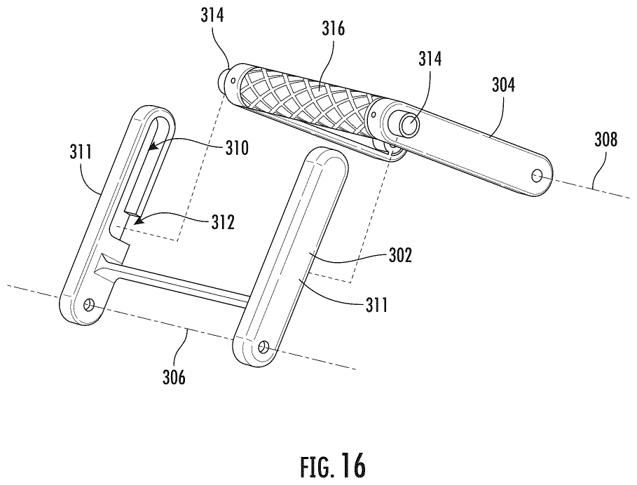

With reference to FIG. 16, the first handle portion 302 includes channels 310 formed in the inner surfaces of legs 311 that have mouths 312 that receive connecting pins 314 of the second handle portion 304. The pins 314 are sized and configured to be received in channels 310 through mouths 312 as well as to slide axially within channels 310. This allows the pins 314 to remain within the channels 310 in both orientations shown in FIG. 13 and FIG. 14.

Thus, after folding the griddle 200 into the packed state and with the handle portions 302, 304 engaged, the user can grab and push or pull the grip member 316 to transition between the handle positions illustrated in FIGS. 13 and 14. But when the user pulls the grip member 316 to transition from the orientation of FIG. 14 to transition to the orientation of FIG. 13, the handle 300 remains substantially balanced allowing for easy carrying of griddle 200. However, the handle 300 can then be transitioned to the flat orientation illustrated in FIG. 16 for storage purposes.

Griddle 200 includes a larger number of louvers 320 formed in the chassis and particularly in first and third chassis portions 310, 314. These louvers 320 improve air flow through the griddle 200 when in the packed state to allow for improved cooling of the internal components of the griddle 320 after use.

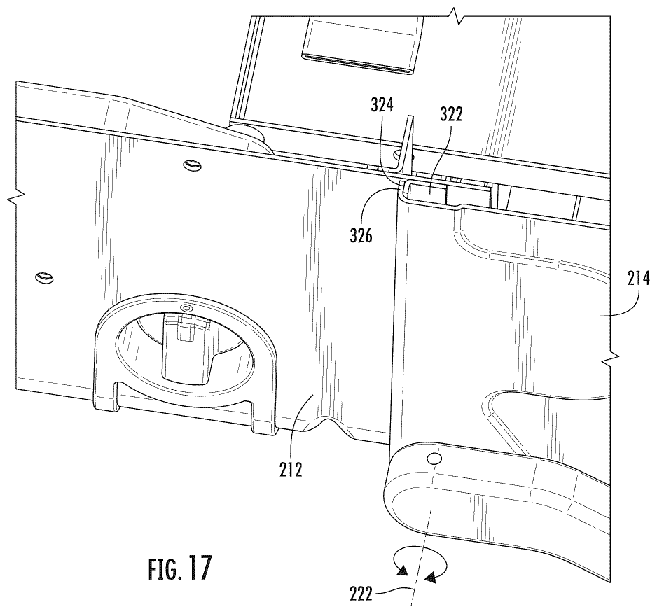

With reference to FIG. 17, griddle 200 includes rotation limiters 322. The rotation limiters 322 are affixed to the second chassis portion 312 and prevent over rotation of the first and third chassis portions 310, 314 (only third chassis portion 314 being shown in FIG. 17) when transitioning from the packed state to the open state. Here, the rotation limiters 322 provide an abutment 324 that abut an inner surface of an inward extending flange portion 326 of the corresponding first and third chassis portions 310, 314. Thus, when the first and third chassis portions 310, 314 are in the proper position relative to the second chassis portion 312 the first and third chassis portions 310, 314 are prevented from further rotating. This simplifies setup of the griddle 200 when transitioning from the packed state.

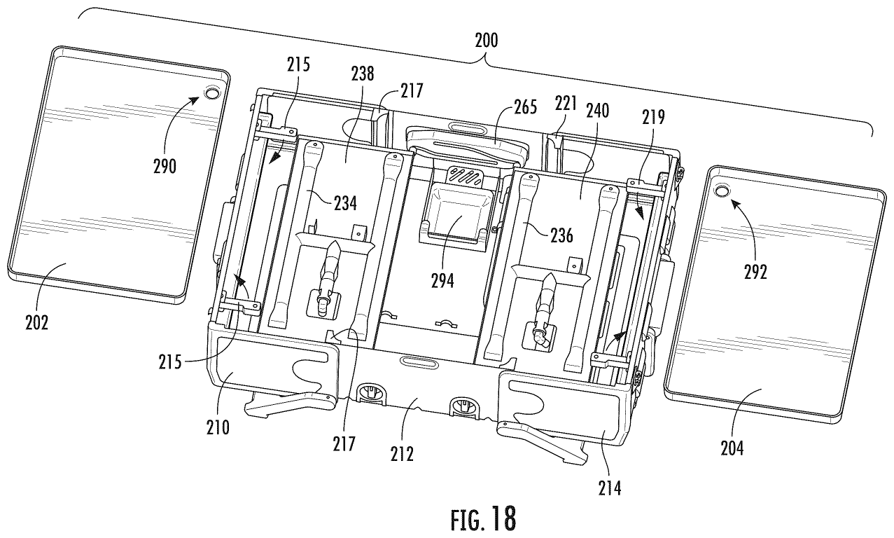

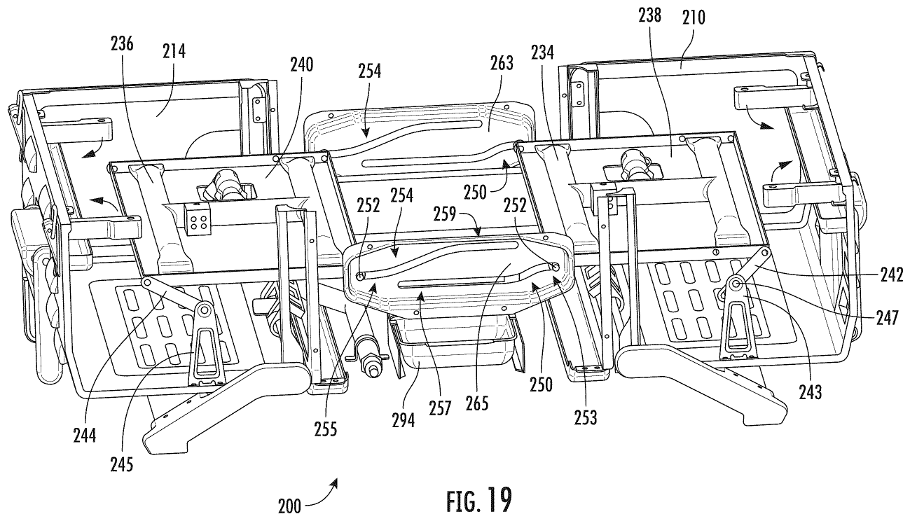

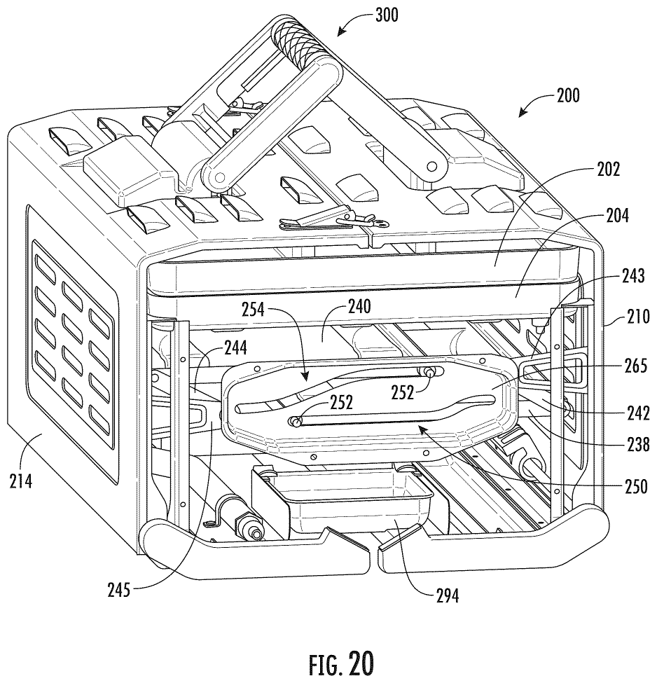

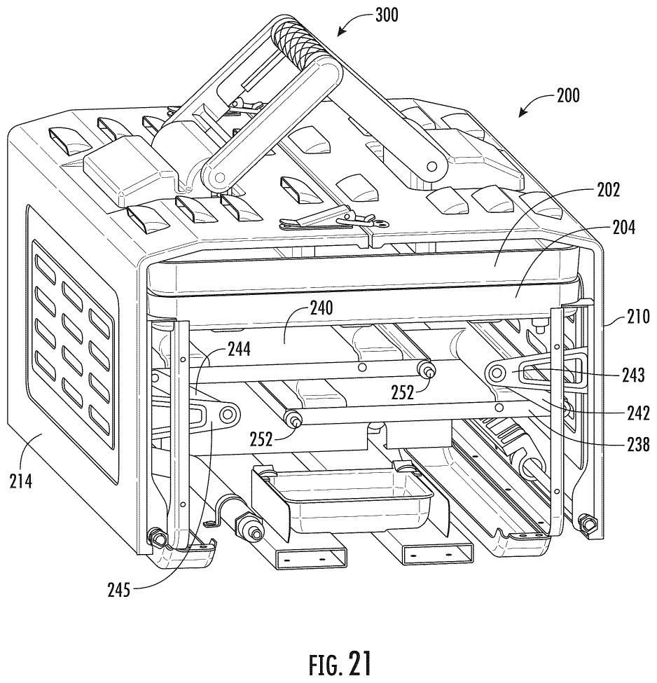

With reference to FIGS. 18 and 19, griddle 200 has retractable griddle plate supports 215, 219 that are pivotally attached to the first and third chassis portions 210, 214. These griddle plate supports 215, 219, at least in part, support the griddle plates 202, 204 in the open state and in use. However, to assist in transitioning to the packed state, these griddle plate supports 215, 219 rotate as illustrated by the arrows in FIG. 18 to a retracted orientation. In addition to griddle plate supports 215, 219, griddle 200 includes support surfaces 217, 221.

In this example the first griddle plate 202 is supported by griddle plate supports 215 and support surfaces 217 while the second griddle plate 202 is supported by griddle plate supports 219 and support surfaces 221.

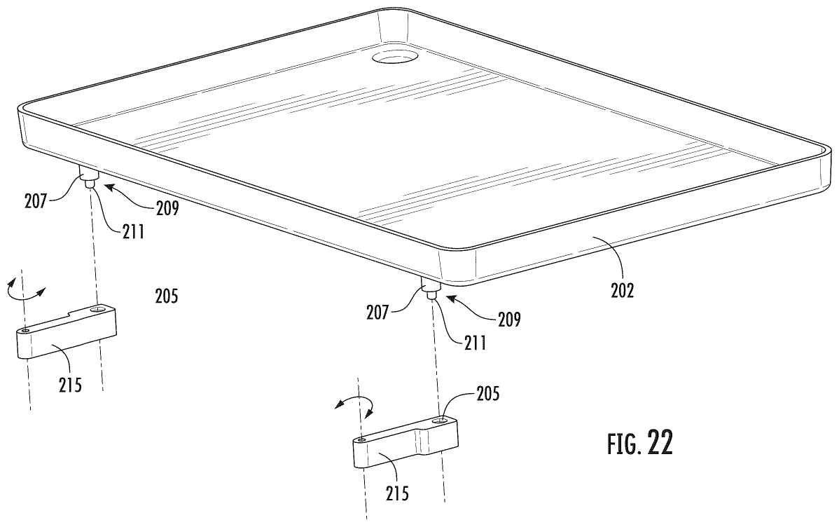

With reference to FIG. 22, griddle plate supports 215, 219 (only griddle plate 215 being shown) include receiving cavities 205 that receive locating stubs 207. The engagement between the cavities 205 and stubs 207 fixes the position of the griddle plates 202, 204 relative to the chassis. In this example, the locating stubs 207 have a stepped region 209 such that the tip 211 has a reduced diameter. The stepped region 209 abuts a top surface of the griddle plate supports 215, 219.

In this example, support surfaces 217, 221 are provide by the second chassis portion 212.

While locating pins in the form of stubs 207 are illustrated, other engaging structure are contemplated. For example, the pivoting griddle plate supports 215, 219 could have projections that extend into recessed regions formed in the underside of the griddle plates 202, 204. Further, in some examples, the foldable griddle plate supports 215, 219 only provide vertical support and no additional engaging structure (other than mere vertical support) may be provided between the griddle plate supports 215, 219 and the supported griddle plates 202, 204.

Further, while the griddle plate supports 215, 219 rotate about vertical axis, it is contemplated that they could rotate about horizontal axis, e.g. folding upwards when not in use during the packed state.

Much like griddle 100, the griddle 200 has two burners 234, 236 that are operably mounted to burner support frames. The burner support frames are configured to reposition the burners 234, 236 within the housing formed by the chassis portions 210, 212, 214 when transitioning between the open and packed states.

The burner support frames include burner support plates 238, 240 and movable support linkages illustrated in the form of linkage arms 242, 244. While the burner support frames include the burner support plates 238, 240, to which the burners are mounted, other embodiments may directly incorporate the structures of burner support plates 138, 140 into the primary burner components.

Unlike the single swing arms 142, 144 of the prior example, in this example, two separate linkage arms 242 or 244 are provided for each of the burner support plates 238, 240. One each is viewable in FIG. 19.

In this example, the linkage arms 242, 244 are pivotally attached to frame uprights 243, 245. In this example, linkage arms 242 are also linearly slidable relative to the connection point 247.

In addition to being pivotally attached to frame uprights 243, 245, the linkage arms 242, 244 are pivotally attached to the corresponding burner support plates 238, 240.

Similar to griddle 100, griddle 200 has the inner edges of the burner support plates 238, 240 supported for sliding motion by way of sliding interaction between cam followers 252 and cam tracks 250, 254 for adjusting the position of the burner support plates 238, 240 (as well as associated burner 234, 236) between the open state and packed state. Once again, these cam tracks 250, 254 have the corresponding first portions 253, 255 that are generally aligned with one another that relate to the open state as well as the second portions 257, 259 that are vertically offset from one another that relate to the packed state.

Again, when the first and third chassis portions 210, 214 are folded towards the packed state, the cam followers 252 will travel along the cam tracks 250, 254 to vertically offset the burner support plates 238, 240 to allow for orienting the burner support plates 238, 240 and consequently burners 234, 236 in a generally vertically stacked configuration. Note, being vertically stacked in this instance does not require the components to actually vertically touch one another.

This orientation is substantially the same as for griddle 100. However, in this example, cam tracks 250, 254 have slightly different shapes where as cam tracks 150, 154 were substantially identically shaped.

In this example, cam tracks 250, 254 are formed in a deep drawn brackets 263, 265 that are otherwise fixed to the rest of the second chassis portion 212. In other examples, these brackets, such as in griddle 100, may be otherwise formed such as by way of stamping, bending, cutting, machining, etc.

With reference to FIG. 18, griddle plates 202, 204 have grease drains 290, 292 proximate corners thereof. In this example, drains 290, 292 are holes formed in the cooking surface of the griddle plates 202, 204. Below these drains 290, 292 can be supported a grease drip tray 294. Typically, the grease drip tray 294 will be supported by the second chassis portion 212 below the drains 290, 292.

While examples illustrate the use of two independent griddle plates 102/104 or 202/204 that provide the entirety of cooking surface, other cooking surface arrangements are contemplated. In some examples, it is contemplated to provide a substantially continuous and/or planar cooking surface substantially free of a gap at the seam between adjacent griddle plates as well as free of the upstanding wall that extends around the periphery of each of the griddle plates 102/104 or 202/204, as illustrated.

In one contemplated example, the adjacent griddle plates are laterally pushed into one another to limit the amount of debris that would fall between the griddle plates in use. Here, the upstanding walls that extend around the griddle plates could be removed such that the cooking surface is substantially flat and continuous when transitioning from one griddle plate to the adjacent griddle plate.

In one contemplated example, the griddle plates could be hingedly attached to one another. The hinge thereof would significantly inhibit debris from falling between the adjacent griddle plates in use. The hinge thereof would inter-engage the two griddle plates.

In another contemplated example, the pair of griddle plates have inter-engaged flanges. One griddle plate would have an upward extending flange and the other griddle plate would have a downward extending flange. Each flange would form an adjacent parallel extending groove with the rest of the body of the associated griddle plate. In use and in the open state, each flange would extend into the groove of the other griddle plate to interconnect the pair of griddle plates.

A further example might incorporate tongue and groove inter-engagement between the griddle plates.

As used herein, “inter-engaged” does not include simply two adjacent griddle plates abutting one another as such an arrangement could allow for a gap to form therebetween in use.

These hinged and inter-engaged designs could provide a substantially continuous cooking surface but reduce the risk of debris (grease, food or otherwise) from dripping through the seam between the adjacent griddle plates in the open state. However, these arrangements would allow for the griddle plates to still be stacked one on top of the other when in the closed or packed state.

A further example could incorporate a third component that could extend across the seam formed between two adjacent griddle plates. This would additionally reduce the risk of debris dripping through the seam between adjacent griddle plates. Ideally, such a third component would be foldable, rollable or otherwise configured such that it could fit within the chassis when in the closed or packed state.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A foldable griddle comprising:
a chassis having first, second, and third chassis portions, the first chassis portion being pivotally attached to the second chassis portion and the third chassis portion being pivotally attached to the second chassis portion, the first and third chassis portions pivotable between open and packed states relative to the second chassis portion;
a first burner support frame operably pivotally attached to the first chassis portion and operably supported by the second chassis portion for sliding lateral and vertical movement relative to the second chassis portion; and
a second burner support frame operably pivotally attached to the third chassis portion and operably supported by the second chassis portion for sliding lateral and vertical movement relative to the second chassis portion;
wherein:
transitioning from the open state to the packed state adjusts vertical positioning of the first burner support frame relative to the second burner support frame and reduces a distance between laterally outermost extents of the first and second burner support frames such that the first and second burner support frames are more laterally compact in the packed state than in the open state.

2. The foldable griddle of claim 1, further including a first griddle plate that is supported by at least the first chassis portion in the open state and a second griddle plate that is supported by at least the third chassis portion in the open state.

3. The foldable griddle of claim 1, wherein the second chassis portion and first burner support frame have a first cam arrangement therebetween that allows for a sliding relationship therebetween that permits both lateral adjustment and vertical adjustment of the first burner support frame relative to the second chassis portion.

4. The foldable griddle of claim 3, wherein the second chassis portion and second burner support frame have a second cam arrangement therebetween that allows for a sliding relationship therebetween that permits both lateral adjustment and vertical adjustment of the second burner support frame relative to the second chassis portion.

5. The foldable griddle of claim 4, wherein the first cam arrangement transitions the first burner support frame a first vertical direction relative to the second chassis portion and the second cam arrangement transitions the second burner support frame a second vertical direction relative to the second chassis portion, the second vertical direction being opposite the first vertical direction.

6. The foldable griddle of claim 3, wherein the first cam arrangement includes a first cam track provided by the second chassis portion and a first cam follower provided by the first burner support frame.

7. The foldable griddle of claim 4, wherein:
the first cam arrangement includes a first cam track provided by the second chassis portion and a first cam follower provided by the first burner support frame;
the second cam arrangement includes a second cam track provided by the second chassis portion and a second cam follower provided by the second burner support frame.

8. The foldable griddle of claim 7, wherein the first cam track is in the form of a slot and the second cam track is in the form of a slot.

9. The foldable griddle of claim 7, wherein:
the first cam track has a first portion associated with the open state, a second portion associated with the packed state and a transition portion that vertically offsets the first portion relative to the second portion;
the second cam track has a first portion associated with the open state, a second portion associated with the packed state and a transition portion that vertically offsets the first portion relative to the second portion;
the first portion of the first cam track and the first portion of the second cam track are substantially coaxial at a same first vertical height.

10. The foldable griddle of claim 9, wherein the second portion of the first cam track is vertically offset from the second portion of the second cam track.

11. The foldable griddle of claim 10, wherein:
the second portion of the first cam track is vertically offset from the first vertical height;
the second portion of the second cam track is vertically offset from the first vertical height;
the first vertical height is vertically between the second portions of the first and second cam tracks.

12. The foldable griddle of claim 1, further comprising first and second rotation limiters provided by the second chassis portion, the first chassis portion engaging the first rotation limiter in the open state preventing over rotation of the first chassis portion relative to the second chassis portion when transitioning from the packed state to the open state and the third chassis portion engaging the second rotation limiter in the open state preventing over rotation of the third chassis portion relative to the second chassis portion when transitioning from the packed state to the open state.

13. The foldable griddle of claim 1 further comprising:
a first griddle support pivotally attached to the first chassis portion pivotable between a retracted state and an extended state;
a first griddle plate being vertically supported on the first griddle support when in the open state and the first griddle support is in the extended state.

14. The foldable griddle of claim 13, wherein the first griddle plate has a locating pin and the first griddle support has a cavity, the locating pin extending into the cavity when the first griddle plate is installed during the open state.

15. The foldable griddle of claim 1, further comprising first and second griddle plate sections supportable by the chassis in a side-by-side configuration when in the open state and in a substantially stacked configuration when in the packed state.

16. The foldable griddle of claim 15, wherein the first and second griddle plates are inter-engaged with one another by way of:
being hingedly attached to one another such that the griddle plates can be folded one on top of the other when in the packed state;
including inter-engaging alternatingly directed vertically extending flanges that inter-engage; or
including tongue and groove engagement.

17. A method of folding up a foldable griddle of claim 1 comprising:
rotating the first chassis portion relative to the second chassis portion from the open state to the closed state;
rotating the third chassis portion relative to the second chassis portion from the open state to the closed state;
transitioning the first burner frame over the second burner frame while the first burner support frame remains attached to the first chassis portion and the second burner support frame remains attached to the third chassis portion.

18. The method of claim 16, wherein transitioning the first burner support frame over the second burner support frame while the first burner support frame remains attached to the first chassis portion and the second burner support frame remains attached to the third chassis portion includes reducing a distance between laterally outermost extents of the first and second burner support frames.

19. The method of claim 16, wherein transitioning the first burner support frame over the second burner support frame while the first burner support frame remains attached to the first chassis portion and the second burner support frame remains attached to the third chassis portion includes sliding a first cam follower of the first burner support frame along a first cam track of the second chassis portion.

20. The method of claim 18, further comprising sliding a second cam follower of the second burner support frame along a second cam track of the second chassis portion.

21. The method of claim 19, wherein:
sliding the first cam follower of the first burner support frame along a first cam track of the second chassis portion adjusts a vertical position of the first burner support frame in a first vertical direction; and
sliding the second cam follower of the second burner support frame along the second cam track of the second chassis portion adjusts a vertical position of the second burner support frame in a second vertical direction opposite the first vertical direction.

22. A foldable griddle comprising:
a chassis having first, second, and third chassis portions, the first chassis portion being pivotally attached to the second chassis portion and the third chassis portion being pivotally attached to the second chassis portion, the first and third chassis portions pivotable between open and packed states relative to the second chassis portion;
a first burner support frame operably pivotally attached to the first chassis portion and operably supported by the second chassis portion for sliding lateral and vertical movement relative to the second chassis portion; and
a second burner support frame operably pivotally attached to the third chassis portion and operably supported by the second chassis portion for sliding lateral and vertical movement relative to the second chassis portion;
a handle having:
a gripping portion to be gripped by a user;
a first handle portion pivotally attached to the first chassis portion and having an elongated channel;
a second handle portion pivotally attached to the second chassis portion and having an outward extending pin fixed relative to a gripping portion of the handle and insertable and axially slidable within the elongated channel such that the first and second handle portions are movable relative to one another between a flat orientation and an extended orientation while the pin remains within the channel.
